(19) United States
(12) Patent Application Publication
(10) Pub. No.: US 2007/0142929 A1
(43) Pub. Date: Jun. 21, 2007

(54) Specifying optional and default values for method parameters

(75) Inventor: Joel C. D. Pereira, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/305,669

(22) Filed: Dec. 16, 2005

(51) Int. Cl. G05B 11/01

(52) U.S. Cl. 700/12

(57) ABSTRACT

An embodiment provides a way to handle default parameters in a method call that are not constant values. During the compiling process of a source code method a compiler generates code before the method body, for every optional parameter. The generated code checks if each optional parameter has a valid value. If a known tag is found then the code generated evaluates the default expression and assign the return value to the corresponding parameter. During the compiling process of a source code method call a compiler, or a semantic analyzer, identifies the defined arguments in the method call. If any arguments are missing, the process uses a known tag for the missing argument. Once all parameter have valid values, passed as arguments or returned from the default expression evaluation, then the original method body is executed.

### BACKGROUND

Computer programs in various programming languages, such as C# and Visual Basic, require parameters to be defined during method calls. Typically the programmer provides the parameters for the method call. Currently, programmers have attempted to have default values for the parameters when no value is provided. However, it has been difficult if not impossible to accommodate variable default values for non-specified parameters.

Modern programming languages usually provide some way to specify default values for method parameters when no value is specified in the caller side of the method call. This processing allows developers or other users to call methods specifying only the parameters they know and have available. This results in a productivity increase which is generally due to the fact that minimal information about the method is required to start calling the method and using the given API.

Even if the given API has been designed to allow developers to specify several different behaviors in a single method call, there are few ways to handle missing parameters in the method call. One approach currently used is by specifying default values for the missing parameters. However, these approaches are currently limited to fixed integer or string values.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments provide a way to handle optional arguments in a method call that corresponds to optional parameters with default values in a method. During the compiling process of a source code method call a compiler, or a syntactic and semantic analyzers, identifies the defined arguments in the method call. If the arguments are missing and the corresponding parameters have default values defined, the process identifies these as optional arguments. During runtime the default value for the missing argument is then evaluated and assigned to the correct parameter before the method body execution.

### BRIEF DESCRIPTION OF THE DRAWINGS

FIG. 1 is a block diagram of one computing environment in which some embodiments may be practiced.

FIG. 2 is a block diagram illustrating the components of a compiler in which some embodiments may be practiced.

FIG. 3 is a flow diagram illustrating the steps executed by the compiler according to various embodiments.

FIG. 4 is a flow diagram illustrating the steps executed during runtime according to various embodiments.

FIG. 5 is a flow diagram illustrating the steps executed that are executed when a method is compiled having an optional parameter according to various embodiments.

### DETAILED DESCRIPTION

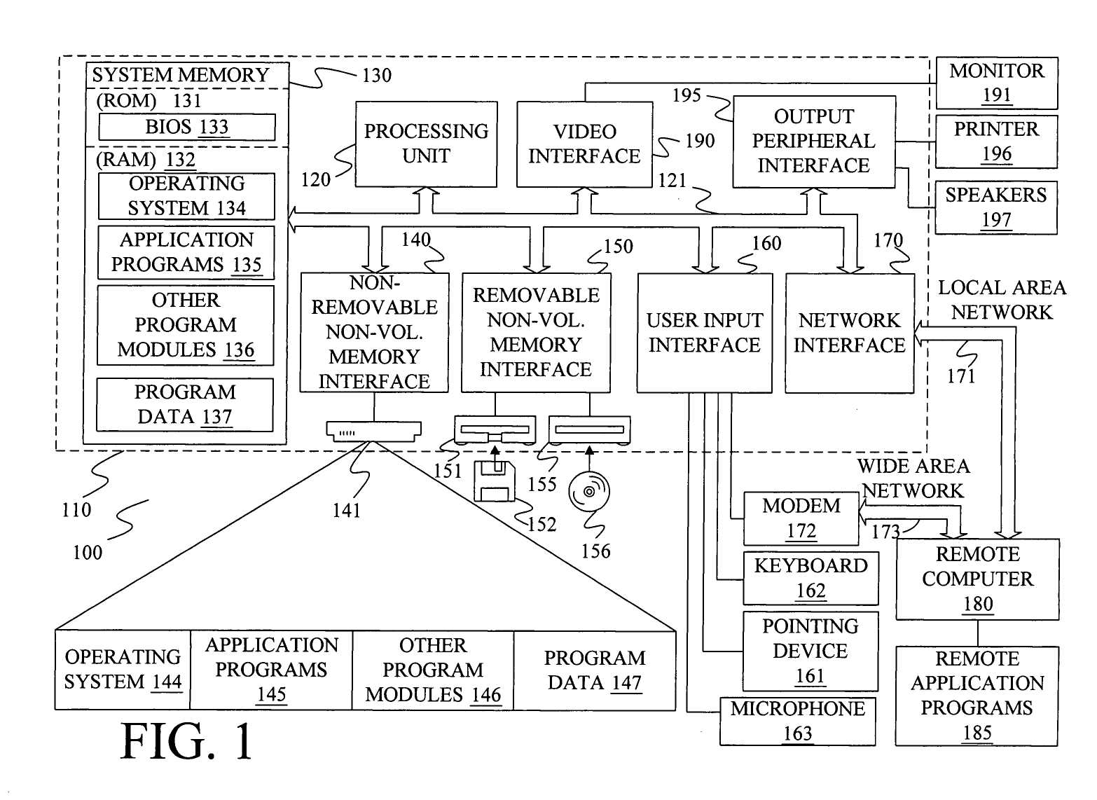

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Modern programming languages such as C# or VisualBasic.Net (VB.Net) generally provide some way to specify default values for method parameters when no value is specified as argument in a method call. This allows developers or other users to call methods specifying only the parameters they know and have available. This generally makes the developers fairly productive. As discussed in the Background this productivity increase is generally due to the fact that minimal information about the method is required to start calling the method and using the given API. Also as previous mentioned even if the given API has been designed to allow developers to specify several different behaviors in a single method call, there are ways to handle missing parameters in the method call. One approach currently used is by specifying default values for the missing parameters. For example, a method declaration in some hypothetical programming language is provided below:

Void MethodA (INT P1, INT P2=3, INT P3=(GetP3), INT P4) { }

In the above method declaration the first parameter has no defined default value. However, it must be of type integer. The second parameter is also an integer entry, but where no argument is defined its default value is set to 3. The third parameter is also of type integer and where no argument is defined the default value for the parameter is provided by the result of a call to the method GetP3. The fourth entry is similar to the first entry.

In this example, a programmer or user can write the following valid method calls for the above method declaration.

| | |
|---|---|
| MethodA (0, 1, 2, 3) | Call 1 |
| MethodA (0, , , 3) | Call 2 |
| MethodA (0, 1, , 3) | Call 3 |
| MethodA (0, , 2, 3) | Call 4 |

Call 1 does not use any additional information about the default values for the missing arguments because all arguments are specified. Call 2 specifies only arguments for the mandatory parameters P1 and P4. Arguments for the parameters P2 and P3 will be defined by their default expressions. Therefore, in the above example, P2 will be assigned to the integer value of 3, and P3 will be assigned to return the value from the method call GetP3. Calls 3 and 4 are variations of Call 2 where P3 and P2 are not specified, respectively.

Currently, there are few ways for supporting the above described scenario. For example, in VB.Net it is possible to specify constants as default values for parameter methods in the method signature. However, two things in the above example are not implemented in programming languages such as VB.Net. First, it is not possible in VB.Net to specify a method call for a default value such as defined at parameter P3. Secondly, it is not possible to declare a mandatory parameter after an optional parameter.

The programming languages such as those used in generating Microsoft Intermediate Language (MSIL) have a limited support from common language runtime (CLR) to implement optional parameters and the default values. It is possible to define method parameters as optional and their corresponding default values. However, this information is stored as metadata that is used by compilers consuming this method, i.e., compiler that have to generate code for a method call to such a method. When a compiler identifies a method call where a portion of the arguments for the call are missing, the compiler then reads the metadata for each parameter in the target method to see if the parameter is optional. If the parameter is optional, the compiler generates the method call code using the defined default value for the optional parameter.

This approach has a number of problems. A first problem with the above approach is that when the method being called, the target method, changes a default value that a certain parameter should have, all the code previously compiled by the compiler using the previous metadata information is out of date because it is using the old values for the metadata. To avoid using old metadata the developer has the option to use version information to differentiate the old code from the new code. However, the above approach is highly error prone and all the client code must still be recompiled. A second problem that is present is that the default values assigned to parameters when arguments are missing, must be constants. The values cannot be expressions or calls to other methods. Further, there is currently no robust way to overcome these limitations using native CLR support.

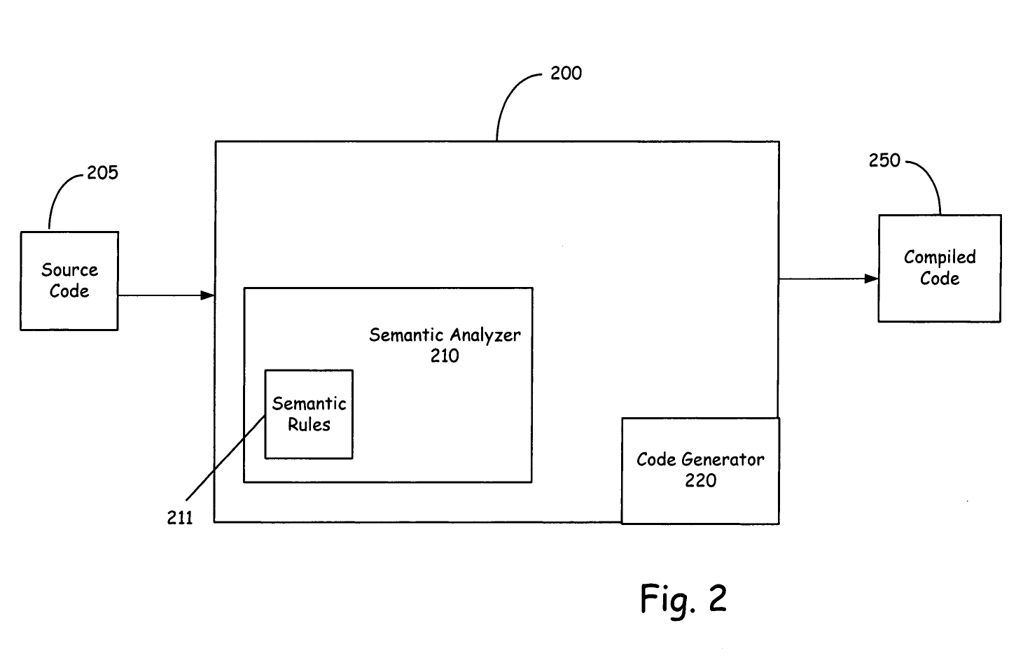

The embodiments described below illustratively address one or both of these two issues using a new structure. In various embodiments, discussed herein, this structure is referred to as an optional parameter. The new structure works together with compiled time through code generation to call and verify the parameters with values and at runtime to calculate the values of the missing parameters. To address the problems described above, embodiments include compile time support and run time support. FIG. 2 illustrates a compiler 200 according to various embodiments. Compiler 200 receives source code 205 and outputs a compiled version of the code 250 in the appropriate language. The compiler provides the compiled version of the code 250 to a processor or other component able to execute compiled code. Compiler 200 also includes a semantic analyzer 210 that operates according to semantic rules 211 and a code generator 220.

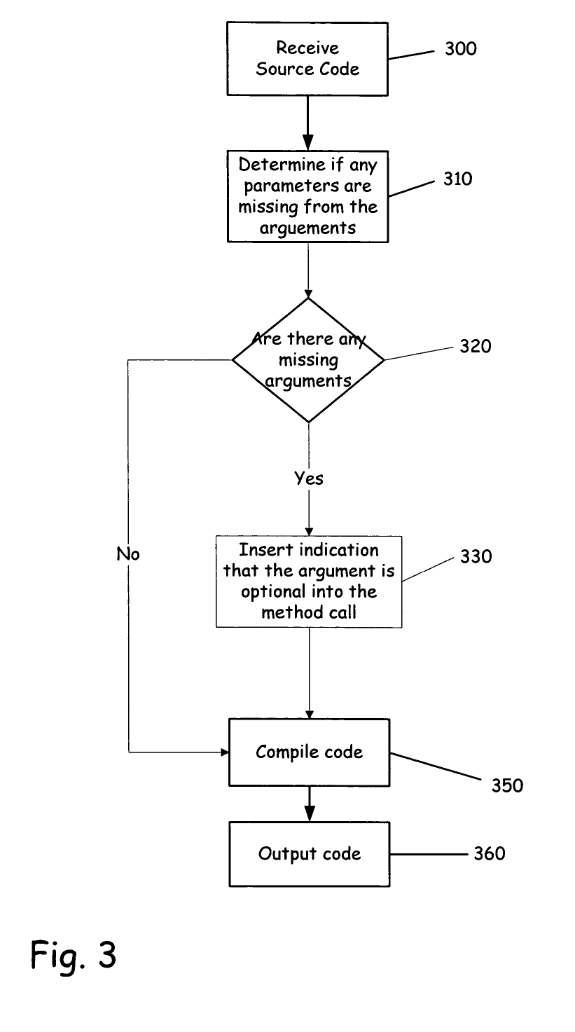

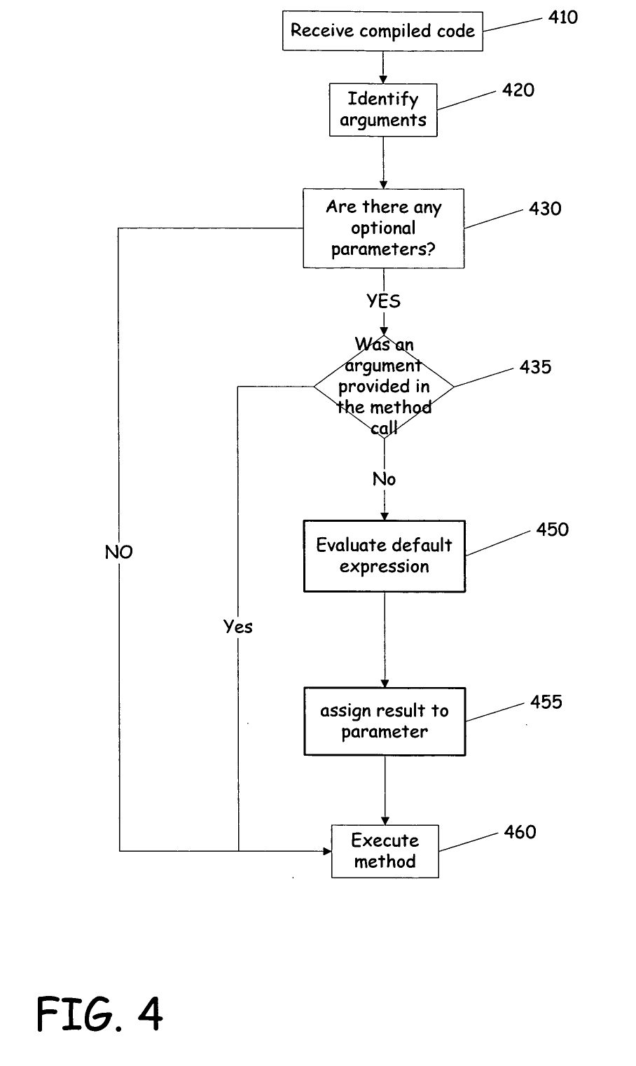

The detailed operation of compiler 200 in identifying missing arguments in method calls is described below with respect to FIG. 3. The execution of the compiled code at runtime is described below with respect to FIG. 4. In overall operation, compiler 200 verifies semantic rules 211 to validate the default expressions declared within the method for each parameter. The analysis of the semantic rules 211 is accomplished through the use of the semantic analyzer 210. Semantic analyzer 210 applies a predetermined set of semantic rules 211 that are developed according to the methods applicable to the programming language. At this time compiler 200 identifies any optional argument for each method parameter that is identified by the semantic analyzer 210 and that is determined to be optional. Generally, this process occurs in the code generator 220, as it can generate both the code for the method and the method call.

Depending on the specific programming language construction used by the developer, compiler 200 can use a different set of semantic rules 211 to verify against a given method declaration. The following is an example of semantic rules 211 that can apply to a compiler 200 according to one implementation. However, it is possible to use additional or different semantic rules or a subset of rules described below.

The formal method parameter list includes of one or more separated parameters, such as the parameters discussed above. The parameters can be of two types, a mandatory parameter or an optional parameter. Mandatory parameters include a type and an identifier which represent the parameter type and name, respectively. Optional parameters include a type, an identifier and an expression which represent, respectively, the parameter type, name and default expression. The default expression is used when an optional parameter is not specified during the method invocation.

Generally speaking, the parameter names must be unique for a given method declaration. These parameters can be referenced by the code inside the method, by their identifiers. When an optional parameter default expression is present it illustratively should not contain any reference to another optional parameter declared after the original optional parameter in the same parameter list. In other words, the default expression for the second parameter, which is an optional parameter, illustratively should not be a method call to another method using the third parameter, which is also a optional parameter, as argument. In one embodiment, the second parameter does not contain any reference to any local variables declared in the method call body. This restriction can be provided to help prevent the system from getting stuck into a continuous loop. However, other embodiments are not subject to these limitations.

A mandatory parameter receives its value from the corresponding argument in the method invocation. The optional parameter may receive its value from the corresponding argument in the method invocation. When a corresponding argument is not specified in the method invocation, the optional parameter illustratively receives its value from the evaluation of the default value expression supplied in the optional parameter declaration. After being initialized both optional and mandatory parameters can be modified and assigned new values.

All reference within the method body that point to an optional parameter change to access the parameter property of the associated class. The following is an example of a method using the optional parameter feature according to one illustrated embodiment.

Class Test

{

Static int GetNext(intp1)
{

Return p1++;

}
Static int Sum (int p1, intp2=GetNext(p1))
{

Return p1+p2;

}
Static void Main( )
{

Int p = Sum(1);

}

}

Following compiling of the above method in the compiler 200 the following code is exported to use with the optional parameter. The outputted code is represented by element 250 in FIG. 2.

Class Test

{

Static int GetNext(intp1)
{

Return p1++;

}
Static in Sum(int p1, OptionalParameter<int>p2)
{

If (!p2.HasParameter)
{

p2.Value = GetNext(p1);

}
Return p1 + p2.Parameter;

}
Static void Main( )
{

Int p = Sum(1, new OptionalParameter<int>( ));

}

}

FIG. 3 is a flow diagram illustrating the steps executed by the compiler 200 during the process of identifying missing parameters within a method call. At step 300, compiler 200 receives source code 205. From the source code 205 the compiler 200 determines whether there are any missing parameters or optional parameters provided in the method call. This is illustrated at step 310. If an optional parameter is determined to be missing, the compiler 200 at step 330 assigns the missing parameter an indication that it is a member of an optional parameter class. This indication is provided, in one embodiment, if the missing parameter is defined either by a default expression or a second method call. In some embodiments when a missing argument corresponding to an optional parameter is found by the compiler, a tag or special class is used for that argument in the method call. This special class is used by the method body to identify if the default expression should be evaluated and assigned to the parameter or not. Once any indications that the missing argument corresponds to an optional parameters, are identified, the compiler continues the process of compiling the code. This is illustrated at step 350. Once the compiling process is completed the compiled code 250 is output at step 360. This output can be stored on a storage device for use later, or can be sent directly to a computer, such as computer 110 for processing according to the process defined in FIG. 4 below.

FIG. 4 is a flow diagram illustrating the steps executed when the compiled code having an optional parameter is executed in a computer. At step 410 the compiled code is accessed by the processor or other component that is capable of executing compiled code. The processor then identifies the arguments in the method call. These arguments include both the defined parameters and any identified optional parameters. The arguments are identified at step 420.

Once the arguments have been identified, the processor then jumps to execute the modified method body. The modified method body identifies any optional parameters in the method call. This is illustrated at block 430. If no optional parameters are present the processor merely executes the code associated with the method at step 460. However, if an optional parameter is present the processor then proceeds to obtain the value for the argument associated with the optional parameter. The processor calls the optional parameter class and determines if an argument was provided in the method call This is illustrated at step 435. If the argument is not provided in the method call the processor executed the default expression associated to the optional parameter. This is illustrated at step 450. Following the processing of the default expression the value returned is assigned to the optional parameter. This assignment of the optional parameter is illustrated at step 455.

Once the values for the optional parameters have been provided, the processor can proceed to execute the desired method. The execution of the method is illustrated at step 460.

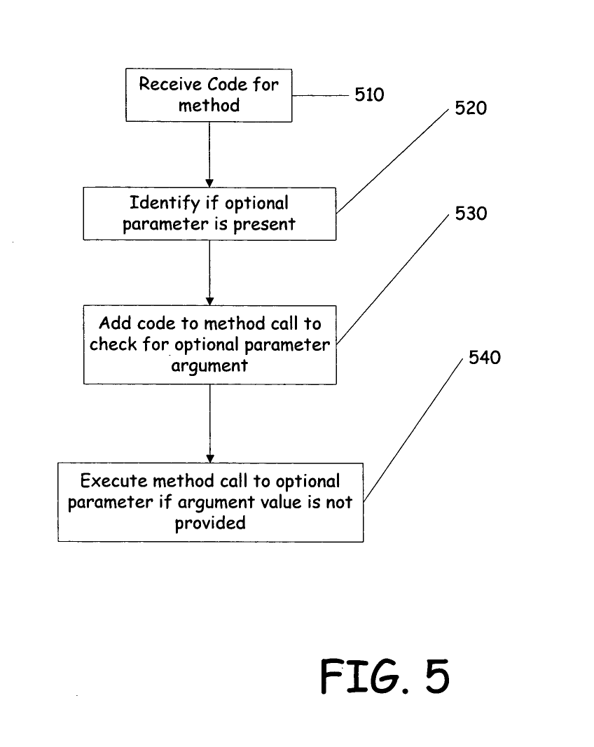

FIG. 5 is a flow diagram illustrating the steps that are executed when a method is compiled having an optional parameter. At step 510 the compiler receives a method containing code. The compiler identifies if there is an optional parameter in the method. This is illustrated at step 520. If an optional parameter is present, the compiler changes that method by adding a block of code in the beginning of the method body to check if the optional parameter has a value passed to it in the method call. This is illustrated at step 530. If no argument was specified in the method call then the default expression will be executed and its result will be assigned to the parameter and used during the method execution. This is illustrated at step 540. If a value is provided then that value is used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for managing an undefined parameter in a method call, comprising:
receiving source code;
identifying in the source code a first method call having arguments;
verifying in the method call that all parameters are defined;
if not all the parameters are defined determining if the undefined parameter is required;
if the undefined parameter is not required, indicating that the parameter is optional in the first method call's arguments; and
compiling the first method call.

2. The method of claim 1 further comprising:
executing the first method call on a computer;
determining if any of the arguments in the first method call were identified as optional;
applying a default argument for each parameter that was identified as optional;
if the default argument for the optional parameter is a second method call, then accessing the second method call associated with default argument; and
inserting a value returned from the second method as the default argument.

3. The method of claim 2 wherein the second method call is defined in an original method definition.

4. The method of claim 2 wherein the second method call is defined in the first method call.

5. The method of claim 1 further comprising:
outputting a compiled method call to a device capable of executing the compiled method call.

6. The method of claim 1 wherein the step of verifying the parameters occurs within a semantic analyzer.

7. The method of claim 6 wherein the semantic analyzer is a component of a compiler.

8. A data structure configured to manage at least one undefined parameter in a method call, comprising:
code that causes a method call to be made;
at least one defined parameter; and
at least one undefined parameter having a default value determined by a method call.

9. The data structure of claim 8 further comprising:
at least one undefined parameter having a default value defined by a predetermined value.

10. The data structure of claim 8 further comprising:
a second undefined parameter having a default value determined by a method call.

11. The data structure of claim 10 wherein the second undefined parameter default value is determined by a second method that is different from the first method.

12. The data structure of claim 8 wherein the data structure is configured for use in C# programming language.

13. The data structure of claim 8 wherein the data structure is configured for use in Visual Baisc.NET programming language.

14. A computer system comprising:
a compiler configured to generate a compiled version of a source code; and
a semantic analyzer configured to identify a missing parameter from a method call that is defined by a default value determined by a second method call.

15. The computer system of claim 14 wherein the semantic analyzer is a component of the compiler.

16. The computer system of claim 14 further comprising:
a code generator configured to generate code for the method call and the second method call in a desired language.
